(19) United States
(12) Patent Application Publication
(10) Pub. No.: US 2025/0359660 A1
(43) Pub. Date: Nov. 27, 2025

(54) DISPOSABLE TOOTHBRUSH HEAD INCORPORATING BRISTLES MADE USING MISWAK OR NEEM

(71) Applicant: Omer Elrayah, Manchester, NH (US)

(72) Inventor: Omer Elrayah, Manchester, NH (US)

(21) Appl. No.: 18/671,994

(22) Filed: May 23, 2024

(51) Int. Cl. A46D 1/00; A46B 3/08; A46B 5/00; A46B 9/04; A46B 9/06; A46B 13/02; A46B 15/00; A46D 1/06; A46D 3/04; A61C 17/22

(52) U.S. Cl. CPC A46D 1/0207; A46B 3/08; A46B 5/0095; A46B 9/04; A46B 9/06; A46B 13/02; A46B 15/0081; A46B 15/0097; A46D 1/006; A46D 1/0215; A46D 1/06; A46D 3/04; A61C 17/222

(57) ABSTRACT

A toothbrush head having a bristle support head with a plurality of miswak or miswak extract or neem or neem extract bristle tufts embedded in the bristle support head, surrounded by a plurality of synthetic bristle tufts embedded in the bristle support head, the plurality all of the bristle tufts together providing the mechanical efficacy of synthetic bristle tufts, while also providing the chemical benefits of miswak or miswak extract or neem or neem extract bristle tufts, thereby improving gingival health, salivation, and antimicrobial activity, while avoiding harmful wear on gingival tissue and occlusal damage to teeth. Also, a toothbrush head having a bristle support head with a plurality of miswak extract or neem extract bristle tufts embedded in the bristle support head, the plurality of extract bristle tufts together providing the mechanical efficacy of synthetic bristle tufts while also providing the chemical benefits of miswak extract or neem extract.

### FIELD OF THE INVENTION

This invention relates generally to toothbrushes, and particularly to toothbrushes and toothbrush heads that include bristles made from natural materials.

### BACKGROUND OF THE INVENTION

The medicinal herbal plant known as miswak comes from the Salvadora persica tree, and has the properties of being antibacterial, anti-fungal, anti-viral, anti-cariogenic, anti-plaque, anti-gingivitis, antioxidant, analgesic, antiulcer, anti-inflammatory, teeth whitening, orthodontic chain preserving, and biocompatible. While miswak has been a widely recognized oral hygiene tool for generations, neem twigs have also demonstrated similar benefits. Both miswak and neem twigs have been traditionally used for dental hygiene due to their natural antibacterial, antimicrobial, and antifungal properties.

Research studies focusing on examining the antibacterial effect have shown that both aerobic and anaerobic bacteria are affected by miswak's antimicrobial activity. Using an aqueous assay and methanol extract, researchers Al-Bayati and Sulaiman were able to investigate the antimicrobial activities of miswak against seven clinically isolated oral microorganism, in 2008. The researchers concluded that amongst all the tested microorganism, the Streptococcus species (Staphylococcus aureus, Streptococcus mutans, Streptococcus faecalis, Streptococcus pyogenes) were the most sensitive. The researchers also noted that both miswak and neem extracts had equal antifungal activity against Candida albicans, a fungus. Sofrata et al., in 2008, suggests that miswak consists of volatile active antibacterial compounds after a vitro study using miswak, which resulted in a strong antibacterial effect against all bacteria tested. The bacteria tested in this study, include Streptococcus mutans, Lactobacillus acidophilus, Aggregatibacter actinomycetemcomitans, Porphyromonas gingivalis, and Haemophilus influenzae, have implicated periodontitis and caries progression abilities.

Based on their in vitro study, Elangovan et al, revealed that aqueous extracts of neem (Azadirachta indica) showed the greatest antimicrobial activity against Streptococcus mutans, while miswak (Salvadora persica) extracts showed superior antimicrobial activity against Lactobacillus acidophilus.

Regarding antifungal effects, Candida albicans occurs most ® commonly in immunocompromised patients and is responsible for multiple infections in the oral cavity. A study in 1994, isolated aqueous extract of miswak with oral isolate of Candida albicans showed that at 15% extract concentrations or more resulted in a fungistatic effect for up to 48 hours. The author of this study, Al-Bagieh et al., suggested that the fungistatic properties where due many of miswak's component, like Chlorine, Trimethylamine, Alkaloid resin, and Sulphur. In addition, a vitro assessment by Paliwal et al., in 2007, found that antifungal activity of S. persica leaf was as comparable to Clotrimazole against Aspergillus niger, Aspergillus flavus, Aspergillus xylinium.

Regarding antiviral effects, miswak has properties found to be very preventative for controlling infections. In 1994, Al-Bagieh investigated S. persica virucidal effects against herpes simplex virus-1 (HSV-1). The results indicated that miswak's main component, Benzyl isothiocyanate (BITC), has anti-herpes against herpes simplex virus type 1 activity.

Regarding Anti-cariogenic effects, Streptococcus mutans has been identified as the most significant microbe contributing to dental carious lesions amongst infants, toddlers, children and adults. Thus, investigating the antimicrobial ability of miswak against this microorganism is pivotal to conclude the efficacy of miswak as being anti-decay. In 2012, Al-Sohaibani and Murugan concluded that S. persica consists of rich bioactive antibacterial and anti-biofilm agents that offer dual functionalities by inhibiting the initial adhesion of cariogenic pioneer colonizing Streptococcus bacteria and subsequently the accumulation of biofilm formation. This study compared the effects of miswak with a conventional toothbrush against S. mutans using DNA-DNA hybridization methods. The results indicated that S. mutans is the most susceptible pathogen by Miswak and the reduction in number of S. mutans was far greater in Miswak users as compared to conventional toothbrush users. The results suggest that utilizing miswak offers an innovative strategy to combat dental carious lesions due to its antibacterial action against pathogens associated with periodontal disease and dental caries. A study conducted in Iran, in 2010, demonstrated the anti-decay effect of miswak in preventing dental caries. This clinical trial was carried out by 330 high school students for a year, of which 174 students used the miswak. Each group was given the same training and cleaning sessions per day. The results of the yearlong trial revealed that a significant 55% increase in the rate of dental caries, for each tooth, was present in the 156 students using the toothbrush as was compared to the miswak users. The rate of dental caries was 9.35 times higher in toothbrush users. In 2010, Baeshen and Birkhed observed that using miswak soaked in 0.1%-0.5% NaF had remineralization effect on white spot lesions in post-orthodontic patients in just 6 weeks. 80 children ranging from 8 to 9 years of age participated in a 3-month study of which 37 children used miswak, while the other 43 used fluoridated toothpaste. The study saw a decrease in S. mutans levels after the use of the miswak, a finding that was not observed in the control group. This suggests that miswak attenuated cariogenic bacterial colonies and could replace brushing with fluoridated toothpaste due to its anti-plaque and antibacterial properties.

Regarding Antiplaque effects, in 2009, Darout et al. conducted a study in Sudan to evaluate the periodontal status using miswak and conventional toothbrushes amongst 213 men ranging from 20-65 years of age. The study showed that those using miswak showed less gingival bleeding, lower calculus and plaque buildup, lower attachment loss, and lower probing depth when compared to those using a toothbrush. In 2010, 528 participants from India, of which 335 were female, were examined to test the effectiveness of miswak compared to a toothbrush by Shetty et al. Apart from gingival recession that was encountered in those using the miswak, the miswak presented with a significantly higher effectiveness in gingival and periodontal conditions when compared to using a conventional toothbrush. In 2003, Al-Otaibi et al. observed that miswaks ability to remove plaque from the embrasure areas more effective than conventional tooth brushing, ultimately helping to reduce interproximal caries. Al-Otaibi et al. also noted that the amount of Aggregatibacter actinomycetemcomitans in the subgingival plaque was significantly reduced by miswak use than conventional toothbrushing. This indicated that miswak is also able to influence the levels of subgingival microbiota. Utilizing a miswak with or without dentifrices adds no additional benefits. However, when comparing the efficacy of a conventional toothbrush with dentifrices against miswak alone, miswak still significantly reduced plaque more superior when compared to brushing with a conventional toothbrush.

Regarding Effects on Saliva, due to miswak's immediate effects on the composition of saliva, research shows the effectiveness of the miswak against a variety of human pathogens including the formation, development, and progression of dental carious lesions. It is demonstrated that miswak users have an increase in salivary secretion due to its strong flavored taste. This increases saliva buffering capacity allowing it to neutralize acids and reduce the initiation of incipient carious lesions. Miswak demonstrated statistically significant levels of plaque pH and an increase in the calcium and chloride content in saliva immediately after chewing the miswak for 5 minutes. It was found that salivary calcium promotes mineralization of tooth enamel, while chloride inhibits calculus formation. A study showed that the increase of salivary calcium and chloride values remained high until after 4 hours reaching normal values like those who had been brushing with a normal toothbrush. Moreover, in 2013, Khalil et al. found that miswak users also showed higher salivary sodium in dental plaque. This suggest that miswak plays a role in counteracting the drop of plaque pH. Miswak provides critical ions necessary towards caries prevention by aiding in the remineralization effect from frequent acidic exposures.

Regarding tooth whitening effects, tooth discoloration is often corrected with abrasive material such as hydrated silica. Miswak was found to have silica and thus serves as a natural abrasive agent. The potential whitening effect of miswak has been investigated in a 2017 study conduct by Alayan et al. and another study in 2018 by Al-Hammadi et al. Both studies concluded oral health improvement and effective cleaning abilities than the conventional toothbrush. Majority of the miswak users reported feeling fresher and whiter teeth.

Unlike the generally perpendicular bristles of a conventional toothbrush, the bristles of S. persica miswak extend along the long axis of its handle, thereby allowing the facial surfaces of the teeth to be reached more easily. However, users are consequently not able to access all surfaces of the dentition easily. For example, access to both the lingual surfaces and the interdental spaces is reduced. Moreover, the relationship between Miswak and gingival recession was examined by Eid et al. in 1991. The severity of gingival recession was more profound in miswak users than with conventional toothbrush users. Another study observed that the typical use of miswak showed a correlation with occlusal wear.

### SUMMARY OF THE INVENTION

The invention provides an all-natural toothbrush that integrates S. persica miswak bristles with Dupont, natural castor oil, silicone, or other naturally occurring bristles. By integrating both the miswak and composite bristles together in one device the user would be able benefit from the combined effect of the mechanical efficacy of the toothbrush bristles with the chemical effects of miswak to improve their gingival health, enhanced salivation, utilize antimicrobial activity against cariogenic and periodontal pathogens all while avoiding harmful wear on gingival tissue and occlusal damage to teeth.

A general aspect of the invention is a toothbrush head including: a bristle support head; a plurality of miswak bristle tufts or a plurality of neem bristle tufts embedded in the bristle support head; and a plurality of synthetic bristle tufts embedded in the bristle support head, the plurality of miswak bristle tufts or the plurality of neem bristle tufts, and the plurality of synthetic bristle tufts together providing mechanical efficacy of synthetic bristle tufts while also providing chemical benefits of miswak or neem bristle tufts, thereby improving gingival health, salivation, and antimicrobial activity, while avoiding harmful wear on gingival tissue and occlusal damage to teeth.

In some embodiments, the plurality of miswak bristle tufts or the plurality of neem bristle tufts are made from at least one of: miswak, miswak extract, neem, neem extract.

In some embodiments, the plurality of miswak bristle tufts or the plurality of neem bristle tufts are made by: processing miswak twigs or neem twigs to extract a powdered miswak extract or a powdered neem extract; fusing the powdered miswak extract or the powdered neem extract with a moldable material; and molding the powdered miswak extract or powdered neem extract with the moldable material into bristles using injection molding.

In some embodiments, the moldable material is one of: PBT (Polybutylene terephthalate), black silica powder, DuPont® bristle material.

In some embodiments, the plurality of miswak bristle tufts or the plurality of neem bristle tufts are made by: peeling miswak sticks or neem sticks; cutting the miswak sticks or neem sticks into segments; and ensuring that the diameter of each miswak stick segment or neem stick segment falls within a range of approximately 0.20 mm to 0.04 mm to create bristle-like tufts.

In some embodiments, the synthetic bristle tufts are made from at least one of: biodegradable Nylon 1010 (castor oil), Dupont® bristle material, PBT, silicone.

In some embodiments, the plurality of miswak bristle tufts or the plurality of neem bristle tufts are centrally located on the bristle support head, and are surrounded by the plurality of synthetic bristle tufts.

In some embodiments, the plurality of miswak bristle tufts or the plurality of neem bristle tufts are centrally located on the bristle support head, and are arranged as a plurality of pairs of miswak bristle tufts or pairs of neem bristle tufts, and the plurality of pairs of miswak bristle tufts or the plurality of pairs of neem bristle tufts are surrounded circumferentially by a plurality of synthetic bristle tufts.

In some embodiments, the plurality of miswak bristle tufts or the plurality of neem bristle tufts are arranged as a pair of centrally located miswak bristle tufts or neem bristle tufts on the bristle support head, and a plurality of synthetic bristle tufts are located between the pair of miswak bristle tufts or the pair of neem bristle tufts, the pair of miswak bristle tufts or the pair of neem bristle tufts also surrounded by a plurality of synthetic bristle tufts.

In some embodiments, the plurality of miswak bristle tufts or the plurality of neem bristle tufts are arranged as a single centrally located miswak bristle tuft or neem bristle tuft on the bristle support head, and the single centrally located miswak bristle tuft or single centrally located neem bristle tuft is surrounded by a plurality of smaller synthetic bristle tufts.

In some embodiments, the plurality of miswak bristle tufts or the plurality of neem bristle tufts are arranged as a plurality of centrally located rectangular miswak bristle tufts or a plurality of centrally located neem bristle tufts on the bristle support head, surrounded by a plurality of rectangular synthetic bristle tufts.

In some embodiments, the plurality of miswak bristle tufts or the plurality of neem bristle tufts are arranged as a single centrally located round miswak bristle tuft or a single centrally located round neem bristle tuft on the bristle support head, surrounded circularly by a plurality of synthetic bristle tufts.

In some embodiments, the replaceable toothbrush head is configured for use with a manual toothbrush handle.

In some embodiments, the replaceable toothbrush head is configured for use with a powered toothbrush handle.

In some embodiments, the bristle support head of the replaceable toothbrush head is made from one of: bamboo, cornstarch, ABS, silicone, wheat straw, wood, recycled plastics, PLA paper, recycled ocean plastics, hemp, coconut.

In some embodiments, the plurality of miswak bristle tufts or the plurality of neem bristle tufts are embedded in the bristle support head by one of: clamping or binding, to firmly embed the plurality of miswak bristle tufts or the plurality of neem bristle tufts in the bristle support head.

In some embodiments, clamping or binding includes: using a clamping device or clamping fixture to hold the bristle tufts tightly in position to embed the bristle tufts in the bristle support head.

In some embodiments, on a side of the bristle support head opposite to the miswak bristle tufts or neem bristle tufts, exposed endings of the miswak bristle tufts or the neem bristle tufts are configured to serve as a tongue scrapper/brush.

In some embodiments, the toothbrush handle includes a magnet embedded within the toothbrush handle to facilitate easy attachment of the toothbrush handle to a complementary magnetic surface, thereby enabling the toothbrush handle to securely adhere to a rechargeable toothbrush case or other magnetic surface.

Another general aspect of the invention is a toothbrush head including: a bristle support head; and a plurality of miswak extract bristle tufts, or a plurality of neem extract bristle tufts, embedded in the bristle support head, the plurality of miswak extract bristle tufts or the plurality of neem extract bristle tufts providing mechanical efficacy of synthetic bristle tufts while also providing chemical benefits of miswak or neem bristle tufts, thereby improving gingival health, salivation, and antimicrobial activity, while avoiding harmful wear on gingival tissue and occlusal damage to teeth.

In some embodiments, the plurality of miswak extract bristle tufts or the plurality of neem extract bristle tufts are made by: processing miswak twigs or neem twigs to extract a powdered miswak extract or a powdered neem extract; fusing the powdered miswak extract or the powdered neem extract with a moldable material; and molding the powdered miswak extract or the powdered neem extract with the moldable material into bristles using injection molding.

In some embodiments, the moldable material is one of: PBT (Polybutylene terephthalate), black silica powder, DuPont® bristle material.

In some embodiments, the bristle support head is configured for use with a manual toothbrush handle.

In some embodiments, the bristle support head is configured for use with a powered toothbrush handle.

In some embodiments, the bristle support head is made from one of: bamboo, cornstarch, ABS, silicone, wheat straw, wood, recycled plastics, PLA paper, recycled ocean plastics, hemp, coconut.

In some embodiments, the plurality of miswak extract bristle tufts or the plurality of neem extract bristle tufts are embedded in the bristle support head by one of: clamping or binding, so as to form a plurality of tufts of miswak extract bristles or tufts of neem extract bristles that can be firmly embedded in the bristle support head.

In some embodiments, clamping or binding is performed using a clamping device or clamping fixture to hold the bristle tufts tightly in position to firmly embed the bristle tufts in the bristle support head.

In some embodiments, on a side of the bristle support head opposite to the miswak extract bristle tufts or neem extract bristle tufts, exposed endings of the miswak extract bristle tufts or neem extract bristle tufts are configured to serve as a tongue scrapper/brush.

In some embodiments, the powered toothbrush handle includes a magnet embedded within the powered toothbrush handle to facilitate easy attachment of the powered toothbrush handle to a complementary magnetic surface, thereby enabling the powered toothbrush handle to securely adhere to a rechargeable toothbrush case or other magnetic surface.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a perspective view of an embodiment of the toothbrush head having miswak bristle tufts or neem bristle tufts that are embedded centrally in a bristle support head, surrounded by a plurality of synthetic bristle tufts that are embedded peripherally in the bristle support head.

FIG. 2A is a perspective view of an embodiment of the toothbrush head having miswak or neem bristle tufts arranged as a pair of centrally located large bristle tufts embedded on a bristle support head, and a plurality of synthetic bristle tufts embedded between the pair of large bristle tufts, and surrounding the pair of large bristle tufts.

FIG. 2B is a side view of the toothbrush head of FIG. 2A, showing stubs of the miswak or neem large bristle tufts protruding out the opposite side of the bristle support head.

FIG. 3A is a perspective view of an embodiment of the toothbrush head having miswak or neem bristle tufts arranged as a single centrally located large bristle tuft embedded in the bristle support head, the single large bristle tuft surrounded by a plurality of smaller tufts of synthetic bristles.

FIG. 3B is a side view of the toothbrush head of FIG. 3A, showing the stub of the single centrally located large bristle tuft of miswak bristles or neem bristles protruding out the opposite side of the bristle support head.

FIG. 4 is a perspective view of an embodiment of the toothbrush head having miswak bristle tufts or neem bristle tufts arranged as a plurality of centrally located rectangular miswak bristle tufts or neem bristle tufts embedded in the bristle support head, surrounded by a plurality of embedded rectangular synthetic bristle tufts.

FIG. 5A is a front view of an embodiment of the toothbrush head for use with an electric toothbrush handle having miswak bristle tufts or neem bristle tufts arranged as a single centrally located round miswak or neem bristle tuft bundle embedded in the bristle support head, surrounded by a plurality of smaller round synthetic bristle tufts.

FIG. 5B is a side view of the toothbrush head of FIG. 5A, showing the stub of the single centrally located large bristle tuft bundle of miswak bristles or neem bristles protruding out the opposite side of the bristle support head.

FIG. 6 is a top view of an embodiment of the toothbrush head having miswak bristles or neem bristles arranged as three square tufts of miswak bristles or neem bristles, each square tuft of miswak bristles or neem bristles surrounded by four rectangular tufts of miswak bristles or neem bristles, all surrounded by fourteen rectangular tufts of synthetic bristles.

FIG. 7A is a bottom perspective view of the bottom side of a replaceable toothbrush head for connected use with a toothbrush handle, showing the bottom side of the toothbrush handle, and showing both a plurality of miswak bristle tufts or neem bristle tufts and a plurality of synthetic bristle tufts secured to the bristle support head of the toothbrush head.

FIG. 7B is a bottom perspective view of the top side of the replaceable toothbrush head of FIG. 7A for connected use with a toothbrush handle, showing the top side of the toothbrush handle, and showing both a plurality of miswak bristle tufts or neem bristle tufts and a plurality of synthetic bristle tufts secured to the bristle support head of the toothbrush head.

### DETAILED DESCRIPTION

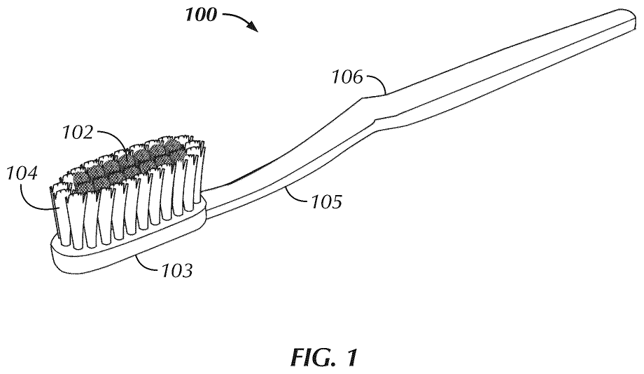

With reference to FIG. 1, an embodiment 100 of the toothbrush head is shown having a plurality of tufts of miswak or neem bristle tufts 102 that are embedded centrally along a bristle support head 103, surrounded by a plurality of tufts of synthetic bristle tufts 104 that are embedded peripherally in the bristle support head 103 that is manipulated using the handle 106. The handle 106 can be integral with the stem 105 that is attached to the bristle support head 103, or can be detachable therefrom. This embodiment 100 of the toothbrush head, conjoined in any manner to the handle 106, forms a toothbrush having a plurality of tufts of miswak or neem bristles 102. The synthetic bristles can be end-rounded, to ensure that the bristles have less damaging effects on tissue.

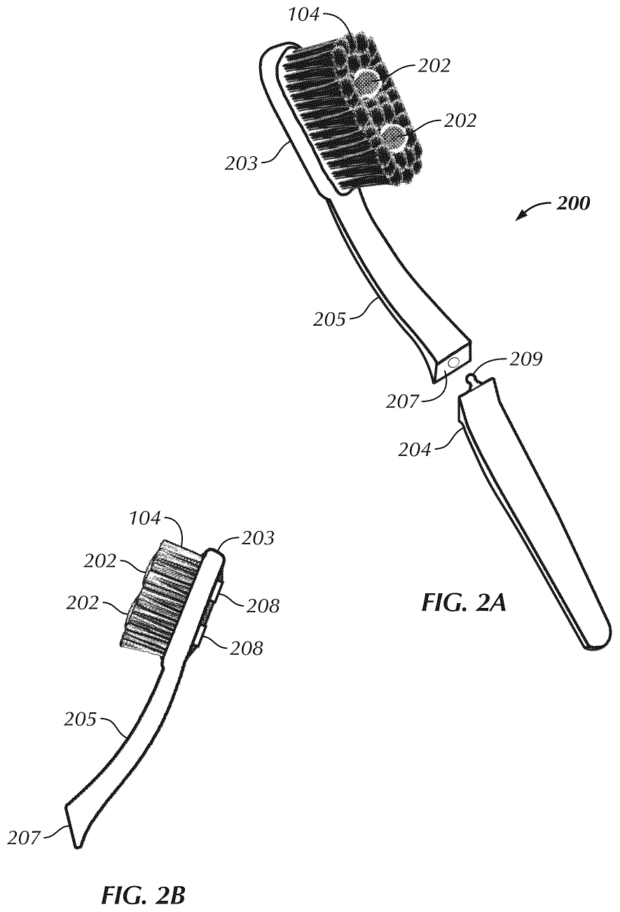

Referring to FIG. 2A, an embodiment 200 of the toothbrush head is shown having two large tufts 202 of miswak or neem bristles arranged as a pair of centrally located bristle tufts embedded on a bristle support head 203. The bristle support head 203 also has embedded a plurality of synthetic bristle tufts 104 located between the pair of large bristle tufts 202, and surrounding the pair of large bristle tufts 202. The toothbrush head 200 also has a stem 205 extending from the bristle support head 203. The stem 205 terminates in a female connector 207 that is cooperative with a male connector 209 at the end of a detachable handle 204.

With reference to FIG. 2B, stubs 208 of the embedded large tufts 202 of the miswak or neem bristles are shown protruding out the opposite side of the bristle support head 203. The stubs 208 can be used as a tongue scraper.

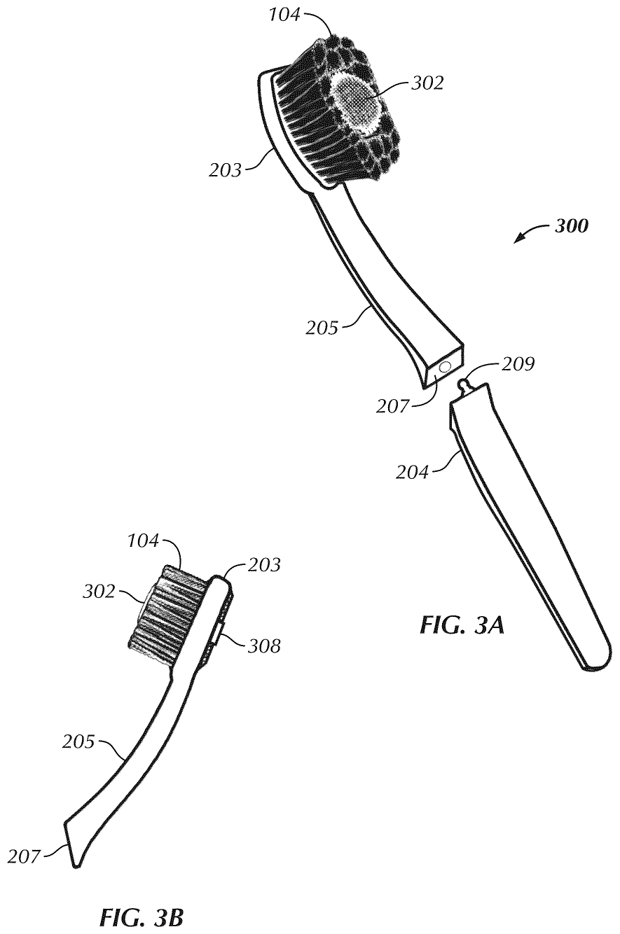

Referring to FIG. 3A, an embodiment 300 of the toothbrush head is shown having miswak or neem bristles arranged as a single centrally located large bristle tuft 302 embedded in the bristle support head 203, the single large bristle tuft 302 surrounded by a plurality 104 of smaller single tufts of synthetic bristles. The toothbrush head 300 also has a stem 205 extending from the bristle support head 203. The stem 205 terminates in a female connector 207 that is cooperative with a male connector 209 at the end of a detachable handle 204.

With reference to FIG. 3B, the toothbrush head 300 of FIG. 3A is shown having a stub 308 of the single centrally located large bristle tuft 320 of miswak or neem bristles that protruds out the opposite side of the bristle support head 203. The stub 308 can be used as a tongue scraper.

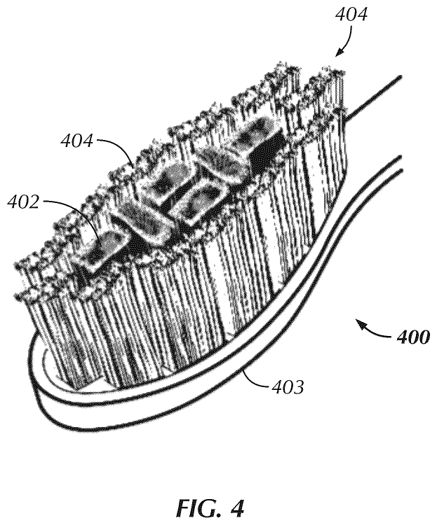

Referring to FIG. 4, an embodiment 400 of the toothbrush head is shown having miswak or neem bristles arranged as a plurality of centrally located rectangular miswak or neem bristle tufts 402 embedded in the bristle support head 403. Surrounding the rectangular miswak or neem bristle tufts 402 are a plurality of embedded rectangular synthetic bristle tufts 404.

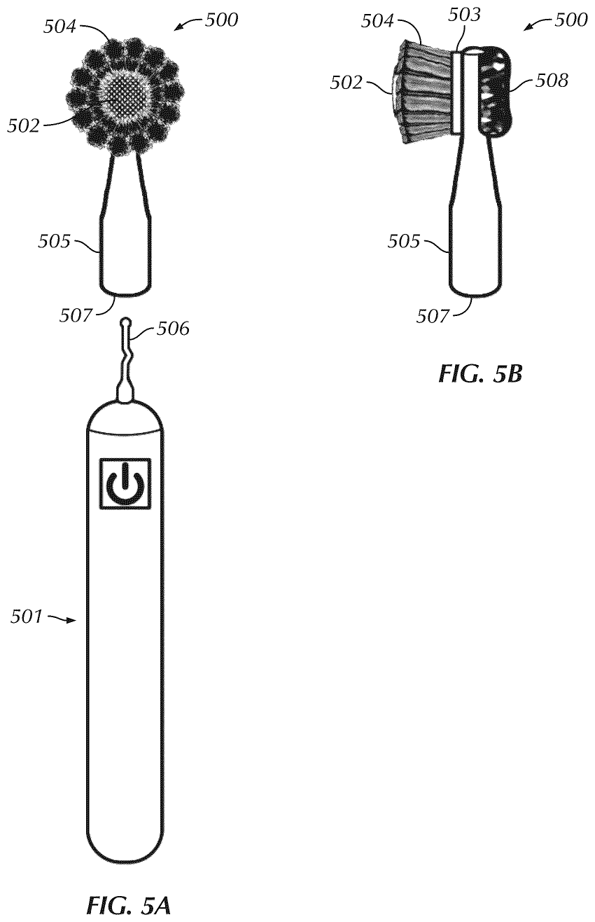

With reference to FIG. 5A, an embodiment 500 of the toothbrush head is shown for use with an electric toothbrush handle 501, the toothbrush head 500 having miswak or neem bristles arranged as a single centrally located large round miswak or neem bristle tuft 502 embedded in the round rotatable bristle support head 503, surrounded by a plurality of smaller round synthetic bristle tufts 504. The round rotatable bristle support head 503 is rotatably supported by the stem 505 that is in rotationally driving relationship with the round rotatable bristle support head 503. The electric toothbrush handle 501 has a rotational drive shaft 506 that is insertable into a drive receptacle 507 of the stem 505 to provide rotational drive to the round rotatable bristle support head 503 via the stem 505.

The powered toothbrush handle 501 can include a magnet (not shown) embedded within the powered toothbrush handle 501 to facilitate easy attachment of the powered toothbrush handle 501 to a complementary magnetic surface (not shown), thereby enabling the powered toothbrush handle 501 to securely adhere to a rechargeable toothbrush case (not shown) or other ferromagnetic surface.

Referring to FIG. 5B, the toothbrush head 500 of FIG. 5A is shown having a stub 508 of the single centrally located large round bristle tuft 502 of miswak bristles or neem bristles that protrudes out the opposite side of the bristle support head 503. The stub 508 can be used as a tongue scraper.

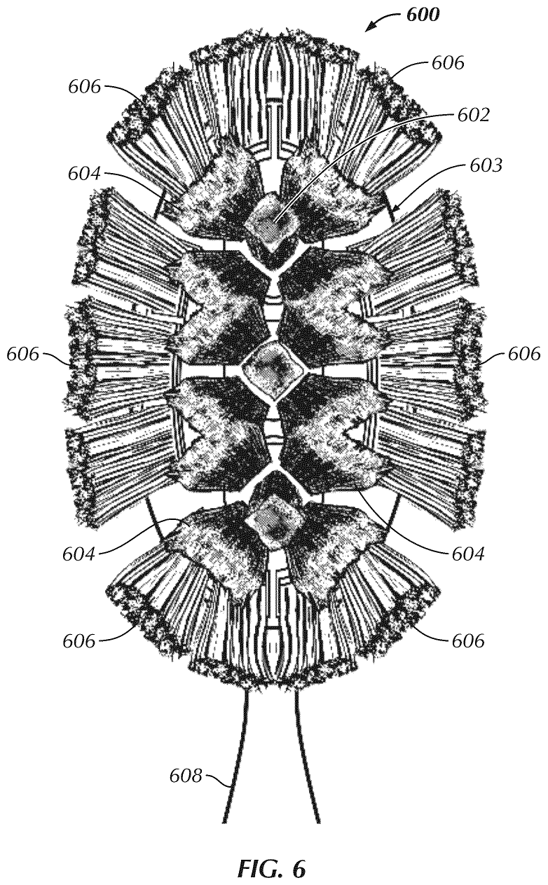

With reference to FIG. 6, an embodiment 600 of the toothbrush head is shown having miswak or neem bristles centrally arranged as three square tufts 602 of miswak or neem embedded in a bristle support head 603. Each square tuft 602 of miswak or neem is surrounded by an arrangement of four rectangular tufts 604 of miswak or neem embedded in the bristle support head 603. The three square tufts 602, and the four rectangular tufts 604 are all surrounded by fourteen rectangular tufts 606 of synthetic bristles embedded in the bristle support head 603. A stem 608 is attached to the bristle support head 603.

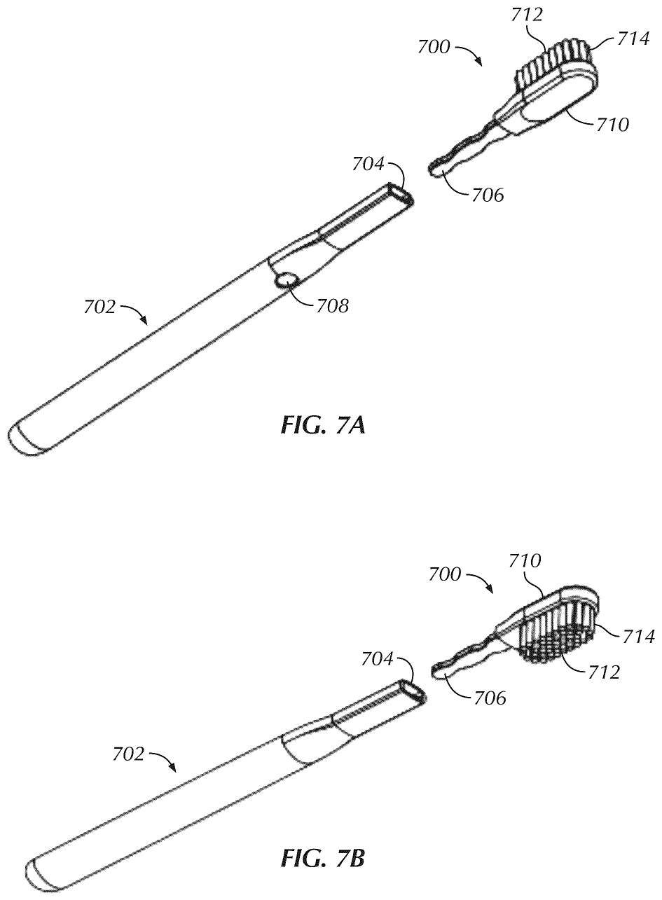

Referring to FIG. 7A, the bottom side of an embodiment 700 of a replaceable toothbrush head is shown for connected use with a toothbrush handle 702, also showing the bottom side of the toothbrush handle 702. The toothbrush handle 702 has a receptacle end 704 for releasably receiving and releasably engaging with the insertable attachment end 706 of the toothbrush head 700. Also shown is a release latch button 708 configured to latch when the attachment end 706 is inserted into the receptacle end 704, and configured to release the attachment end 706 when the release latch button 708 is continuously pressed into the handle 702.

This embodiment 700 of the toothbrush head also includes a bristle support head 710 having a plurality of miswak extract bristle tufts or a plurality of neem extract bristle tufts 712 embedded in the bristle support head 710 in a manner similar to the embodiment of the bristle support head 103 of FIG. 1.

With reference to FIG. 7B, the top side of the replaceable toothbrush head 700 of FIG. 7A is shown for connected use with the toothbrush handle 702, also showing the plurality of miswak extract bristle tufts or the plurality of neem extract bristle tufts 712 secured to the bristle support head 710 of the toothbrush head 700.

The plurality of miswak extract bristle tufts or the plurality of neem extract bristle tufts 712 are embedded in the bristle support head 710 by one of clamping or binding, to form a plurality of tufts of miswak extract bristles or neem extract bristles 712 that can be firmly embedded in the bristle support head 710. The bristle tufts 712 can be firmly embedded in the bristle support head 710 by using a clamping device or a clamping fixture to hold the bristle tufts 712 tightly in position to firmly embed the bristle tufts in the bristle support head 710.

The process of securely placing bristles on a toothbrush, whether they are nylon bristles, bamboo bristles, Neem bristles or Miswak bristles, involves several steps. Below is a standard way to place nylon bristles onto a toothbrush, followed by a comparison with Miswak or Neem bristles:

### Standard Process for Nylon Bristles:

Bristle Material Selection: The first step in manufacturing a toothbrush is to select the bristle material. In the case of nylon bristles, nylon filaments are commonly used due to their durability and flexibility.
Cutting and Bundling: The selected nylon filaments are cut to the desired length, usually in varying lengths to create different bristle heights on the toothbrush head. These filaments are then bundled together to form tufts.
Tufting: Tufting machines are used to securely anchor the bundles of nylon bristles into the toothbrush head. The toothbrush head typically has pre-drilled holes or channels to accommodate the tufts.
Heat Treatment: After tufting, the toothbrush head is subjected to a heat treatment process. This helps to melt and fuse the base of the nylon bristles, creating a secure anchor within the toothbrush head.
Trimming and Shaping: Excess nylon bristle material is trimmed, and the bristle tips are shaped to achieve the desired bristle profile. This step ensures that the bristles are uniform and provide effective cleaning.
Quality Control: Toothbrushes undergo quality control checks to ensure that bristles are securely anchored, evenly distributed, and meet quality standards.
   Comparison with Miswak and Neem Bristles:
   Miswak and Neem bristles are a natural alternative to nylon bristles, and differ in several ways:
Material Source: Miswak and Neem bristles are derived from plants. These bristles are naturally occurring and do not require the manufacturing processes involved in nylon bristles.
Harvesting and Processing: Miswak and Neem bristles are harvested. They are typically used without extensive processing, other than cleaning, trimming to the desired length, and peeled off. Unlike nylon bristles, Miswak and Neem bristles are not heat-treated or anchored by melting.
Heat treatment is not typically used to secure Miswak or Neem bristles to the toothbrush head. Instead, a mechanical process is employed to hold them in place.
Biodegradability: One significant contrast is in the biodegradability of the materials. Miswak and Neem bristles are biodegradable and eco-friendly, as they are derived from a natural source. Nylon bristles, being synthetic, are not biodegradable, and contribute to plastic waste.
Texture and Properties: Miswak and Neem bristles have a unique texture and natural properties that some users find beneficial for dental care. They contain natural compounds like silica, fluoride, and tannins, which are believed to have oral health benefits.
Durability: Nylon bristles tend to be more durable and longer-lasting compared to Miswak and Neem bristles. Miswak and Neem bristles may wear out more quickly and need more frequent replacement.

There are two primary methods for incorporating miswak and neem with a toothbrush head: Mechanical Securing of Miswak or Neem Bristles, and Fusion of Miswak or Neem as an Extract with Synthetic Materials:
1. Mechanical Securing of Miswak or Neem Bristles: In this method, miswak or neem twigs are mechanically secured onto the brush head using techniques such as clamping, or binding to securely attach the bristles to the toothbrush head. The miswak or neem twigs can be placed individually or in bundles, and they can be positioned alongside or integrated with synthetic bristle materials, such as Dupont or natural castor oil bristles. This method ensures a robust and durable connection between the miswak or neem bristles and the toothbrush head.

The method includes:

Bristle Insertion: Small holes or channels are created in the toothbrush head. Using specialized machinery. These holes are strategically placed to accommodate the bundles of Miswak and nylon bristles.

Mechanical Securing: The bundles of Miswak or Neem and bundles of nylon bristles are inserted into the pre-drilled holes or channels. Various mechanical methods, such as clamping or binding are used to secure the bristle bundles firmly in place.

Creating bundles of Miswak or Neem involves preparing Miswak or Neem sticks and bundling them together.

### Preparing Miswak or Neem Sticks:

Start with peeled Miswak or Neem sticks.

Carefully cut the Miswak or Neem sticks into segments, each measuring approximately 42 mm (millimeters) in length.

This length is commonly used for toothbrush-sized Miswak or Neem bundles.

Ensure that the diameter of each Miswak or Neem stick segment falls within the range of approximately 0.20 mm to 0.04 mm. This diameter range is suitable for creating bristle-like bundles.

The dimensions and arrangements mentioned here are commonly used in the dental care industry to create toothbrushes.

### Bundling the Miswak or Neem Sticks:

Once Miswak or Neem stick segments of the desired length and diameter have been prepared, a suitable number of these segments are gathered to form a bundle.

Next, arrange the Miswak or Neem stick segments in parallel, aligning their cut ends.

Then, secure the bundle by clamping or by tightly wrapping a cord, thread, or other suitable binding material around the aligned ends of the Miswak or Neem stick segments. The binding material should hold the segments together firmly, creating a bundle that resembles a toothbrush head.

Clamping: refers to a mechanical method of securing objects together by applying pressure or force through a clamping mechanism. In the context of bristle bundles, it involves using a clamping device or fixture to hold the bristle bundles tightly in position to secure the bristle bundles to the toothbrush head.

Clamps can be designed in various forms, including spring-loaded clamps, screw clamps, or adjustable clamps. These clamps exert force to press the bristle bundles against a surface or backing material, ensuring they stay in place during use.

Binding is another mechanical method used to secure objects together, especially when dealing with flexible or elongated materials like bristle bundles. In the context of bristle bundles, binding involves using a cord, thread, wire, or other similar material to tie or wrap around the bristle bundle tightly. This process effectively holds the bristles in place and prevents them from separating or shifting.

Binding can be done manually or with the help of automated machinery, depending on the manufacturing process and the desired level of precision.

Trimming and Shaping: Excess bristle material may be trimmed, and the bristle tips are shaped to achieve the desired profile.

After securing the bundle, trim any excess length from the Miswak stick segments to ensure a uniform and neat appearance.

Shape the bundle as needed to achieve the desired bristle-like arrangement, ensuring that the bristles are evenly distributed and provide effective cleaning. This process is similar to trimming and shaping on Nylon bristles.

Quality Control: Toothbrushes undergo quality control checks to ensure that bristles are securely anchored, evenly distributed, and meet quality standards.

Fusion with Raw Materials: Alternatively, the miswak or neem twigs can be processed to extract their powdered extract, which is then fused with raw materials like PBT (Polybutylene terephthalate), black silica powder, DuPont bristle material, or other suitable materials, at elevated temperatures. The fused material is subsequently molded into bristles using injection molding or similar techniques. This process creates miswak-infused or neem-infused bristles that are integrated seamlessly with other bristle types. The fusion method allows for precise control over the distribution of miswak or neem extract within the bristles, ensuring consistent benefits during use.

On the opposite side, each toothbrush head may display exposed endings of the bristles to serve as a tongue scrapper/brush. Because the miswak or neem bristle will not be situated along the long axis of the handle, like it is in natural form, the lingual surfaces and interdental spaces will be reached more easily. This new angulation offers the user better ability to reach the posterior and distal teeth surfaces with greater ease.

Studies report that there are no differences in antibacterial effects between fresh and a one-month-old Miswak or Neem. Despite not expiring, the miswak or neem loses freshness overtime, since it is a natural product. The miswak or neem may react to its surroundings and dry or become too moist. Thus, it is recommended to replace the heads about every month to maintain superior therapeutic effects. Since the replaceable heads are natural and plant based, they are biodegradable and are fully-recyclable. This allows customers to play a large role in the next step towards a greener dental sector.

To obtain optimum oral health and hygiene, miswak or neem can be used alone or as an adjunct to a dentifrice. When using a toothbrush with miswak or neem secured via mechanical securing, the user begins to either chew on the bristles, or lightly brush teeth surfaces in a circle motion until the miswak or neem bristles became soft and frayed. The bristles are then soaked in water briefly and can be used with or without a dentifrice. All surfaces inside the oral cavity maybe brushed gently, including the gums, palate, tongue, under the tongue, and the surfaces inside of the cheek and lips. This toothbrush maybe used to clean the teeth in a similar manner to a modern toothbrush using the rolling technique or modified bass brushing technique. After brushing, the bristles should be briefly rinsed to remove any debris and then kept in a clean dry space that is ventilated.

As with any natural product, mold may occur. So, frequent use of the miswak or neem, and keeping it away from sunlight, is recommended.

Using the combined effects of miswak or neem, and additional synthetic bristles, serves dual function to achieve greater mechanical and chemical benefits. The mechanical plaque control results from the friction of the nylon and miswak or neem fibers against to the tooth surface. While the chemical plaque control is due to the chemical composition of miswak or neem.

In summary, the standard process for securely placing nylon bristles on a toothbrush involves tufting, heat treatment, and trimming. Miswak and Neem bristles, on the other hand, are naturally sourced and do not undergo such extensive manufacturing processes. They offer unique properties but may have different durability characteristics and require more frequent replacement. Additionally, Miswak and Neem bristles are biodegradable, making them a more environmentally friendly option.

The toothbrush head of the invention includes bristles made from Salvadora persica (Miswak), and Azadirachta indica (Neem). Alternatively, the toothbrush head of the invention could add or substitute other natural chewing sticks having dental benefits including: Acacia catechu (Kher), Acacia nilotica (Kikar), Acacia leucophloea (Safed Babu), Achyranthes aspera (Apamarga), Aegle marmelos (Bael tree), Butea monosperma (Dhak), Calotropis procera (Madar Ak), Nerium indicum (Kamer), Pongamia pinnata (Karanj), Pterocarpus marsupium (Vijayasar), Terminalia arjuna (Arjun), Ficus racemosa (Gular), and Zanthoxylum aromatum (Tejovati). These natural chewing sticks possess various properties, such as astringency, antibacterial, antifungal, anti-inflammatory, and analgesic effects, making them also suitable for enhancing oral hygiene and overall dental health.

The toothbrush of the invention can be in the form of a manual toothbrush, a manual toothbrush with replaceable toothbrush heads, or a powered toothbrush with replaceable toothbrush heads. The toothbrush head can be made from bamboo, cornstarch, ABS, silicone, wheat straw, wood, recycled plastics, PLA paper, recycled ocean plastics, hemp, coconut, or other sustainable and biodegradable materials.

Other modifications and implementations will occur to those skilled in the art without departing from the spirit and the scope of the invention as claimed. Accordingly, the above description is not intended to limit the invention, except as indicated in the following claims.

What is claimed is:

1. A toothbrush head comprising:
a bristle support head;
a plurality of miswak bristle tufts or a plurality of neem bristle tufts embedded in the bristle support head; and
a plurality of synthetic bristle tufts embedded in the bristle support head,
the plurality of miswak bristle tufts or the plurality of neem bristle tufts, and the plurality of synthetic bristle tufts together providing mechanical efficacy of synthetic bristle tufts while also providing chemical benefits of miswak or neem bristle tufts, thereby improving gingival health, salivation, and antimicrobial activity, while avoiding harmful wear on gingival tissue and occlusal damage to teeth.

2. The toothbrush head of claim 1, wherein the plurality of miswak bristle tufts or the plurality of neem bristle tufts are made from at least one of:
miswak, miswak extract, neem, neem extract.

3. The toothbrush head of claim 1, wherein the plurality of miswak bristle tufts or the plurality of neem bristle tufts are made by:
processing miswak twigs or neem twigs to extract a powdered miswak extract or a powdered neem extract;
fusing the powdered miswak extract or the powdered neem extract with a moldable material; and
molding the powdered miswak extract or powdered neem extract with the moldable material into bristles using injection molding.

4. The toothbrush head of claim 3, wherein the moldable material is one of:
PBT (Polybutylene terephthalate), black silica powder, DuPont® bristle material.

5. The toothbrush head of claim 1, wherein the plurality of miswak bristle tufts or the plurality of neem bristle tufts are made by:
peeling miswak sticks or neem sticks;
cutting the miswak sticks or neem sticks into segments; and
ensuring that the diameter of each miswak stick segment or neem stick segment falls within a range of approximately 0.20 mm to 0.04 mm to create bristle-like tufts.

6. The toothbrush head of claim 1, wherein the synthetic bristle tufts are made from at least one of:
biodegradable Nylon 1010 (castor oil), Dupont® bristle material, PBT, silicone.

7. The toothbrush head of claim 1, wherein the plurality of miswak bristle tufts or the plurality of neem bristle tufts are centrally located on the bristle support head, and are surrounded by the plurality of synthetic bristle tufts.

8. The toothbrush head of claim 1, wherein the plurality of miswak bristle tufts or the plurality of neem bristle tufts are centrally located on the bristle support head, and are arranged as a plurality of pairs of miswak bristle tufts or pairs of neem bristle tufts, and the plurality of pairs of miswak bristle tufts or the plurality of pairs of neem bristle tufts are surrounded circumferentially by a plurality of synthetic bristle tufts.

9. The toothbrush head of claim 1, wherein the plurality of miswak bristle tufts or the plurality of neem bristle tufts are arranged as a pair of centrally located miswak bristle tufts or neem bristle tufts on the bristle support head, and a plurality of synthetic bristle tufts are located between the pair of miswak bristle tufts or the pair of neem bristle tufts, the pair of miswak bristle tufts or the pair of neem bristle tufts also surrounded by a plurality of synthetic bristle tufts.

10. The toothbrush head of claim 1, wherein the plurality of miswak bristle tufts or the plurality of neem bristle tufts are arranged as a single centrally located miswak bristle tuft or neem bristle tuft on the bristle support head, and the single centrally located miswak bristle tuft or single centrally located neem bristle tuft is surrounded by a plurality of smaller synthetic bristle tufts.

11. The toothbrush head of claim 1, wherein the plurality of miswak bristle tufts or the plurality of neem bristle tufts are arranged as a plurality of centrally located rectangular miswak bristle tufts or a plurality of centrally located neem bristle tufts on the bristle support head, surrounded by a plurality of rectangular synthetic bristle tufts.

12. The toothbrush head of claim 1, wherein the plurality of miswak bristle tufts or the plurality of neem bristle tufts are arranged as a single centrally located round miswak bristle tuft or a single centrally located round neem bristle tuft on the bristle support head, surrounded circularly by a plurality of synthetic bristle tufts.

13. The toothbrush head of claim 1, wherein the replaceable toothbrush head is configured for use with a manual toothbrush handle.

14. The toothbrush head of claim 1, wherein the replaceable toothbrush head is configured for use with a powered toothbrush handle.

15. The toothbrush head of claim 1, wherein the bristle support head of the replaceable toothbrush head is made from one of:
bamboo, cornstarch, ABS, silicone, wheat straw, wood, recycled plastics, PLA paper, recycled ocean plastics, hemp, coconut.

16. The toothbrush head of claim 1, wherein the plurality of miswak bristle tufts or the plurality of neem bristle tufts are embedded in the bristle support head by one of:
clamping or binding, so as to firmly embed the plurality of miswak bristle tufts or the plurality of neem bristle tufts in the bristle support head.

17. The toothbrush head of claim 16, further including:
using a clamping device or clamping fixture to hold the bristle tufts tightly in position to embed the bristle tufts in the bristle support head.

18. The toothbrush head of claim 1, wherein on a side of the bristle support head opposite to the miswak bristle tufts or neem bristle tufts, exposed endings of the miswak bristle tufts or the neem bristle tufts are configured to serve as a tongue scrapper/brush.

19. The toothbrush head of claim 1, wherein the toothbrush handle includes a magnet embedded within the toothbrush handle to facilitate easy attachment of the toothbrush handle to a complementary magnetic surface, thereby enabling the toothbrush handle to securely adhere to a rechargeable toothbrush case or other magnetic surface.

20. A toothbrush head comprising:
a bristle support head; and
a plurality of miswak extract bristle tufts, or a plurality of neem extract bristle tufts, embedded in the bristle support head,
the plurality of miswak extract bristle tufts or the plurality of neem extract bristle tufts providing mechanical efficacy of synthetic bristle tufts while also providing chemical benefits of miswak or neem bristle tufts, thereby improving gingival health, salivation, and antimicrobial activity, while avoiding harmful wear on gingival tissue and occlusal damage to teeth.

21. The toothbrush head of claim 20, wherein the plurality of miswak extract bristle tufts or the plurality of neem extract bristle tufts are made by:
processing miswak twigs or neem twigs to extract a powdered miswak extract or a powdered neem extract;
fusing the powdered miswak extract or the powdered neem extract with a moldable material; and
molding the powdered miswak extract or the powdered neem extract with the moldable material into bristles using injection molding.

22. The toothbrush head of claim 21, wherein the moldable material is one of:
PBT (Polybutylene terephthalate), black silica powder, DuPont® bristle material.

23. The toothbrush head of claim 20, wherein the bristle support head is configured for use with a manual toothbrush handle.

24. The toothbrush head of claim 20, wherein the bristle support head is configured for use with a powered toothbrush handle.

25. The toothbrush head of claim 20, wherein the bristle support head is made from one of:
bamboo, cornstarch, ABS, silicone, wheat straw, wood, recycled plastics, PLA paper, recycled ocean plastics, hemp, coconut.

26. The toothbrush head of claim 20, wherein the plurality of miswak extract bristle tufts or the plurality of neem extract bristle tufts are embedded in the bristle support head by one of:
clamping or binding, so as to form a plurality of bristle tufts of miswak extract bristle tufts or neem extract bristle tufts that can be firmly embedded in the bristle support head.

27. The toothbrush head of claim 26, further including:
using a clamping device or clamping fixture to hold the bristle tufts tightly in position to firmly embed the bristle tufts in the bristle support head.

28. The toothbrush head of claim 20, wherein on a side of the bristle support head opposite to the miswak extract bristle tufts or neem extract bristle tufts, exposed endings of the miswak extract bristle tufts or neem extract bristle tufts are configured to serve as a tongue scrapper/brush.

29. The toothbrush head of claim 23, wherein the powered toothbrush handle includes a magnet embedded within the powered toothbrush handle to facilitate easy attachment of the powered toothbrush handle to a complementary magnetic surface, thereby enabling the powered toothbrush handle to securely adhere to a rechargeable toothbrush case or other magnetic surface.
